(19) United States
(12) Patent Application Publication
(10) Pub. No.: US 2023/0141294 A1
(43) Pub. Date: May 11, 2023

(54) AUTOMOBILE SEAT BASED ON INCLINED ANGLE ADJUSTMENT MECHANISM

(71) Applicant: Magna Seating Research & Development (Chongqing) Co., Ltd., Chongqing (CN)

(72) Inventors: Jiale Zuo, Shanghai (CN); Guogang Chen, Shanghai (CN); Lei Xue, Shanghai (CN)

(21) Appl. No.: 18/069,090

(22) Filed: Dec. 20, 2022

Related U.S. Application Data
(63) Continuation of application No. PCT/CN2022/117025, filed on Sep. 5, 2022.

(30) Foreign Application Priority Data
Nov. 9, 2021 (CN) 202111322469.3

(51) Int. Cl. B60N 2/10; B60N 2/18; B60N 2/02

(52) U.S. Cl. CPC B60N 2/10; B60N 2/181; B60N 2/1853; B60N 2/0232

(57) ABSTRACT

The disclosure discloses an automobile seat based on an inclined angle adjustment mechanism, including a seat body composed of a cushion skeleton, a backrest skeleton, and a base arranged under the seat body. The upper surface of the base is of a non-plane structure and includes a pedestal located at the lower part and a branch located at the upper part which is integrated or connected by a fixed member, the back of the pedestal is movably connected with the lower part of a third connection rod, the upper part of a seventh connection rod is movably connected with the front of a forth connection rod, and the middle of the seventh connection rod is movably connected with the upper end of the branch, and rotation points are located near the H point of the seat.

### CROSS-REFERENCE TO RELATED APPLICATIONS

This application is a continuation of International Patent Application No. PCT/CN2022/117025 with a filing date of Sep. 5, 2022, designating the United States, now pending, and further claims priority to Chinese Patent Application No. 202111322469.3 with a filing date of Nov. 9, 2021. The content of the aforementioned applications, including any intervening amendments thereto, are incorporated herein by reference.

### TECHNICAL FIELD

The present application relates to the field of automobile seats, particularly, to an automobile seat based on an inclined angle adjustment mechanism.

### BACKGROUND OF THE PRESENT INVENTION

As end customers, passengers focus on the function and comfort of automobile seats. In the existing technology, adjustment of the function and comfort of the automobile seat can no longer meet the requirements of passengers, and therefore it is urgent to the application of an automobile device with large angle adjustment. At present, there are some defects for devices based on large angle adjustments on the market.

The application with publication number CN113212258A and entitled “FIVE-CONNECTION ROD STRUCTURE OF SEAT” discloses a five-connection rod device of an automobile seat. This device is driven by two motors, and one of the two motors uses an eccentrically driven angle adjuster to drive the movement of the connection rod fixed on the angle adjuster. As shown in FIG. 1A and FIG. 1B, wherein A represents the seat and M represents the angle adjuster. Due to the eccentric movement of an electric angle adjuster, instability during the seat adjustment can be caused, especially for some special populations such as old men and pregnant women, it is possible to generate more serious influence, so the experience is poor. This device has disadvantages: first, eccentric rotation makes the entire seat shake so that passengers have a poor experience during the adjustment; second, adoption of the two motors and the angle adjuster causes high cost; third, space arrangement requirements are high.

The application with publication number CN109050355A and entitled “ZERO-GRAVITY AUTOMOBILE SEAT” discloses a zero-gravity automobile seat. Two screw motors directly and upwardly push a seat to move, as shown in FIG. 2, the screw motors are arranged in a direction from top to bottom (C refers to the screw motor), which greatly occupies the space at the bottom of the seat and affects other structural arrangements. This device has the following problems: first, adoption of the two motors causes high cost; second, up and down pushing requirements for space are high; third, the motor can withstand the repeated pushing and pull of a human body and the impact force of vehicle collision, and the motor is easily damaged; fourth, the rotation point of the seat is located at the lower junction point, which is far away from an H point, of the connection rod, resulting in a poor experience.

In summary, it is urgent to develop an automobile seat capable of realizing the large angle adjustment of the seat to meet the comfort and function requirements of passengers, and the adoption of a single motor can realize the driven automobile seat.

### SUMMARY OF PRESENT INVENTION

To realize the stable adjustment of the seat, a horizontal arrangement is performed by using a screw rod motor in combination with the existing technology, stable and large-angle adjustment of the seat can be realized by adjusting the structure of the connection rod and the purposes of small space arrangement and stable movement are achieved. Based on this concept, the present application provides an automobile seat based on an inclined angle adjustment mechanism.

The present application is realized by the following technical solution: an automobile seat based on an inclined angle adjustment mechanism, comprising a seat body including a cushion skeleton and a backrest skeleton, and a base arranged under the seat body, further comprising an inclined angle adjustment mechanism, wherein the inclined angle adjustment mechanism comprises a third connection rod, a fourth connection rod and a seventh connection rod, the upper surface of the base is of a non-plane structure and includes a pedestal located at the lower part and a branch located at the upper part which are integrated or connected by a fixed member, the back of the pedestal is moveably connected with the lower end of the third connection rod, the front of the pedestal is moveably connected with a length-variable connection rod, the upper part of the seventh connection rod is moveably connected with the front of the fourth connection rod, the back of the fourth connection rod is moveably connected with the upper part of the third connection rod, the middle of the seventh connection rod is moveably connected with the upper end of the branch, and the length-variable connection rod is connected with a drive device.

Preferably, the length-variable connection rod adopts a threaded nut device, a shaft sleeve device, a sliding block, and chute device, a gear/rack device, or a ball screw device.

Preferably, the threaded nut device comprises a nut sleeve and a rocker, an external thread is arranged on the outside of the rocker, a corresponding internal thread is arranged inside the nut sleeve, the lower part of the seventh connection rod is movably connected with the middle of the nut sleeve, and the middle of the pedestal is movably connected with one endpoint of the rocker.

Preferably, the nut sleeve and the rocker are respectively located on the front upper part of the pedestal, when the nut sleeve forward moves, the nut sleeve is farther and farther away from an intersection point between the rocker and the pedestal, and the inclined angle of the seat is increased.

Preferably, the nut sleeve and the rocker are respectively located on the back lower part of the pedestal, when the nut sleeve forward moves, the nut sleeve is closer and closer to an intersection point between the rocker and the pedestal, and the inclined angle of the seat is increased.

Preferably, the fourth connection rod is fixed at the bottom of the cushion skeleton, or the fourth connection rod is replaced by the cushion skeleton.

Preferably, the electric drive adopts a screw motor, when the screw motor rotates, the rocker is driven to rotate so that the nut sleeve moves along the rocker and meanwhile the rocker swings up and down around a hinge point between the rocker and the pedestal, the movement of the nut sleeve drives the seventh connection rod to rotate around a hinge point located in the middle of the seventh connection rod, the rotation of the seventh connection rod drives the upward movement of the fourth connection rod, and the upward movement of the fourth connection rod drives the downward movement of the third connection rod, to realize the large angle adjustment of the fourth connection rod, and the movement of the fourth connection rod drives the large angle adjustment of the cushion skeleton and the backrest skeleton.

Preferably, the inclined angle adjustment mechanism is connected with a high adjustment mechanism, the high adjustment mechanism comprises a fifth connection rod and a sixth connection rod, and the front and back of the fourth connection rod are respectively movably connected with the lower ends of the fifth connection rod and the sixth connection rod, and the upper ends of the fifth connection rod and the sixth connection rod are respectively movably connected with the cushion skeleton.

The design principle of the present application is as follows: large angle adjustment of the automobile seat is performed so that the passengers realize rest in a lying posture, which has become a common demand of the automobile seat industry today. However, in most cases, the current seat industry adopts the eccentric movement of an electric angle adjuster. Due to the working principle of the angle adjuster, the movement of the seat is nonlinear, and a linkage mechanism has a magnifying effect on the nonlinear movement, resulting in severe vibration of the seat during the movement adjustment, in such the way, the passengers feel very uncomfortable and experience very poor. In view of this, to realize the purposes of how to convert the direct rotation of the seat adjuster into linear movement but simultaneously achieve the goal of large angle adjustment, the present application uses the screw motor to drive the rocker to rotate, so as to increase the length of the length-variable connection rod to drive the rotation, up movement and down movement of other connection rods connected with the length-variable connection rod, thereby finally achieving the rotation of the fourth connection rod. Since the fourth connection rod is directly fixed on the cushion skeleton, the angle change of the automobile seat is simultaneously driven. Since the power for such an angle change fully comes from the rotation of the screw motor, the rest is driven by the physical mechanics between connection rods, such the movement is linear.

Meanwhile, since the hinge point, the hinge point, and the hinge point are all located on the base, and the hinge point is on the hinge point and the hinge point, and are all connected to the base. Such a design allows each connection rod to be more stable when in movement. Finally, when a force is transferred to the third connection rod since the third connection rod downwardly moves and the final stance is on the hinge point of the base, the force on the seat can be dissipated through the third connection rod, and the hinge point and the movement of the seat are steady and uniform. When the passenger uses this function, the passenger feels comfortable and steady.

Beneficial effect: the present application relates to an automobile seat based on an inclined angle adjustment mechanism, which ingeniously designs the upper and lower parts of the base of the automobile seat into upper and lower parts, so that the hinge point, the hinge point, and the hinge point are all located on the base, while the hinge point is on the hinge point and the hinge point, which are connected with the base, and can ensure smooth and even movement of the seat. The rotation of this device is completely driven by physical mechanics between the connecting rods and can be just completed by one motor. The automobile seat based on the inclined angle adjustment mechanism of the present application is low in cost, low in device strength requirement, small in space arrangement requirement, and can rapidly conduct large angle adjustment. Moreover, when the motor is arranged in a horizontal direction, vertical space is greatly reduced, meeting the comfort and function requirements of the passenger, and therefore the automobile seat is very practical.

### DESCRIPTION OF THE DRAWINGS

FIG. 1A and FIG. 1B are schematic diagrams of a seat based on five-connection rod inclined angle adjustment driven by using an angle adjuster in the existing technology.

FIG. 2 is a structural diagram of a zero-gravity automobile seat in the existing technology.

FIG. 3 is a structural diagram of an embodiment of the present disclosure (a threaded nut sleeve and a rocker are respectively located on the front upper part, i.e., left upper part, of the pedestal).

FIG. 4 is a structural diagram of another embodiment of the present disclosure (a threaded nut sleeve and a rocker are respectively located on the back lower part, i.e., right lower part, of the pedestal).

FIG. 5 is a diagram of an original state of an inclined angle of the present disclosure.

FIG. 6 is a diagram of an intermediate state of an inclined angle of the present disclosure.

FIG. 7 is a diagram of a maximum state of an inclined angle of the present application.

FIG. 8A and FIG. 8B are mechanical analysis principle graphs of a movement mechanism of an automobile seat under two inclined angle states of FIG. 5 and FIG. 7, respectively.

FIG. 9 is a diagram of a mechanical movement direction of the present disclosure.

FIG. 10 is a comparison graph of mechanical analysis of an automobile seat under the original inclined adjustment state and the maximum inclined angle adjustment state (rest state).

FIG. 11 is a structural diagram of an embodiment of the present disclosure (a threaded nut sleeve and a rocker are respectively located on the back lower part, i.e., right lower part, of the pedestal).

FIG. 12 is a structural diagram of an embodiment of the present disclosure (a threaded nut sleeve and a rocker are respectively located on the front upper part, i.e., left upper part, of the pedestal).

FIG. 13 is a diagram of an original state of an inclined angle of an automobile seat frame simultaneously using an inclined angle adjustment mechanism and a high adjustment mechanism.

FIG. 14 is a diagram of an intermediate state of an inclined angle of an automobile seat frame simultaneously using an inclined angle adjustment mechanism and a high adjustment mechanism.

FIG. 15 is a diagram of a maximum state of an inclined angle of an automobile seat frame simultaneously using an inclined angle adjustment mechanism and a high adjustment mechanism.

FIG. 16A and FIG. 16B are mechanical analysis principle graphs of a movement mechanism of an automobile seat under two inclined angle states of FIG. 13 and FIG. 15, respectively.

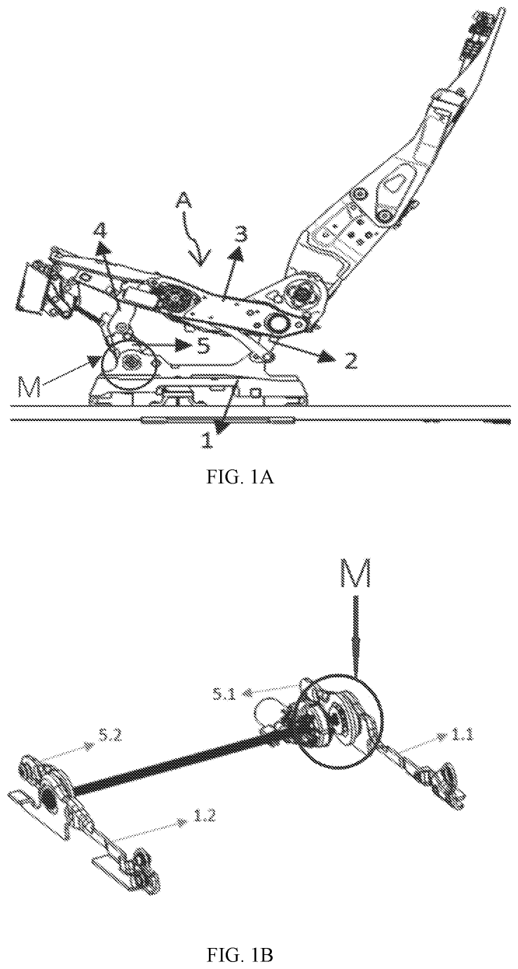

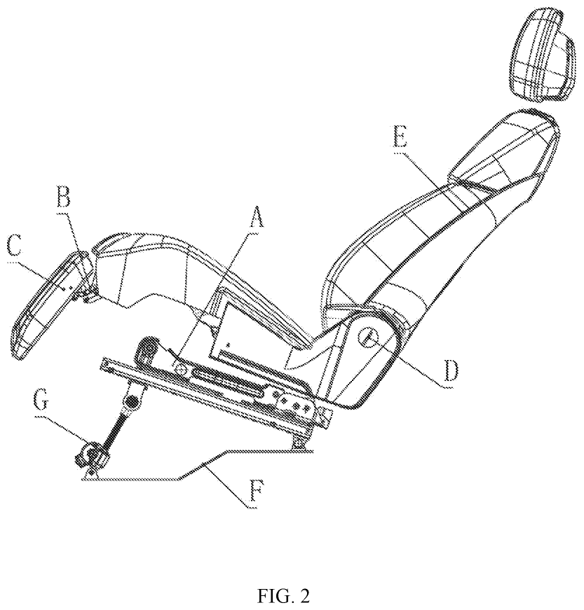

### DETAILED DESCRIPTION OF PREFERRED EMBODIMENTS

The embodiments of the present disclosure will be illustrated in detail in combination with accompanying drawings. The embodiments are implemented on the premise of the technical solution of the present disclosure, and detailed embodiments and specific operation process are given, however, the protective scope of the present disclosure is not limited to the following embodiments.

### Example 1

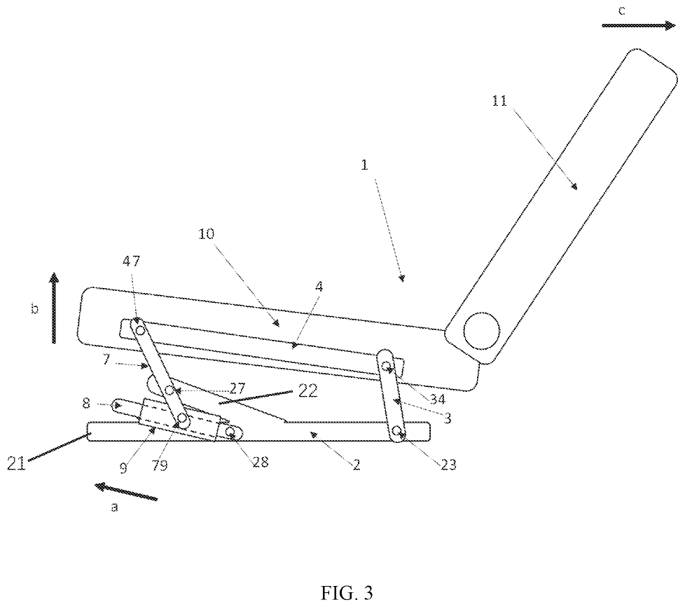

As shown in FIG. 3, FIG. 3 includes a seat body 1 composed of a cushion skeleton 10 and a backrest skeleton 11, and a base 2 arranged under the seat body 1, and further includes an inclined angle adjustment mechanism, wherein the inclined angle adjustment mechanism includes a third connection rod 3, a fourth connection rod 4 and a seventh connection rod 7. The upper surface of the base 2 is of a non-plane structure and includes a pedestal 21 located at the lower part and a branch 22 located at the upper part which are integrated or connected by a fixed member, the back of the pedestal 21 is hinged with the lower end of the third connection rod 3, the front of the pedestal 21 is hinged with a length-variable connection rod, the length-variable connection rod hinged with the lower end of the seventh connection rod 7, the upper end of the seventh connection rod 7 is hinged with the front of the forth connection rod 4, the back of the forth connection rod 4 is hinged with the upper part of the third connection rod 3, the middle of the seventh connection rod 7 is hinged with the upper end of the branch 22. The fourth connection rod 4 is fixed at the bottom of the cushion skeleton 10.

The length-variable connection rod in this example adopts a threaded nut device including a nut sleeve 9 and a rocker 8, an external thread is arranged outside the rocker 8, a corresponding internal thread is arranged inside the nut sleeve 9, the lower part of the seventh connection rod 7 is hinged with the middle of the nut sleeve 9, and the middle of the pedestal 21 is hinged with one end point of the rocker 8. The nut sleeve 9 and the rocker 8 are respectively located on the front upper part of the pedestal 21, when the nut sleeve 9 forward moves, the nut sleeve 9 is farther and farther away from an intersection point between the rocker 8 and the pedestal 21, and the inclined angle of the seat is increased. The nut sleeve 9 and the rocker 8 are respectively located on the front upper part of the pedestal 21, which leaves many spaces for the lower part of the automobile seat to facilitate installation of a drive motor.

### Example 2

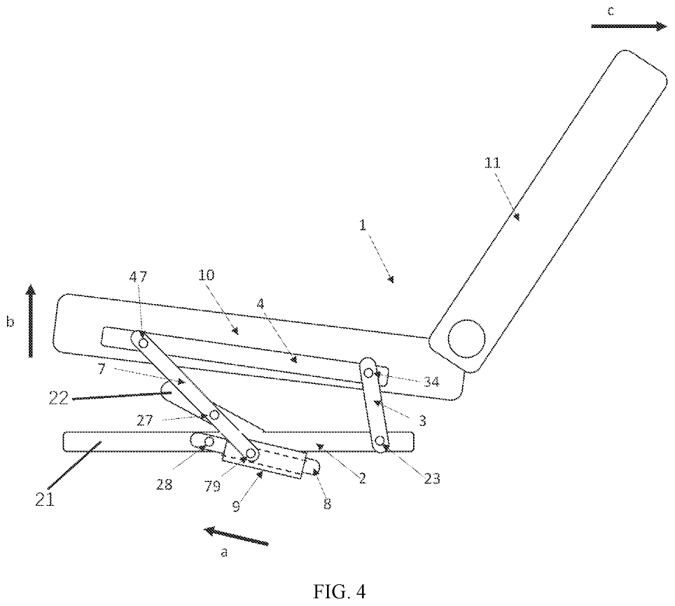

As shown in FIG. 4, the nut sleeve 9 and the rocker 8 are respectively located on the back lower part, i.e., right lower part, of the pedestal 21, when the nut sleeve 9 forward moves, the nut sleeve 9 is more and more close to an intersection point between the rocker 8 and the pedestal 21, and the inclined angle of the seat is increased. The nut sleeve 9 and the rocker 8 are respectively located in the right lower part of the pedestal 21, which leaves a space for the front of the seat to facilitate the design of a leg support device for the front of the automobile seat. Other structures are the same as those in example 1.

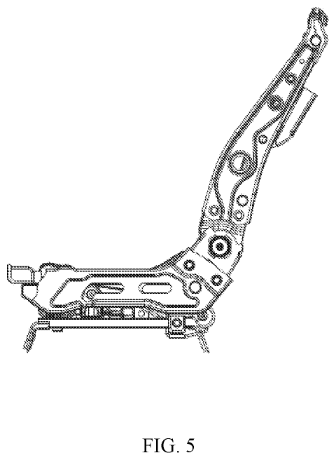

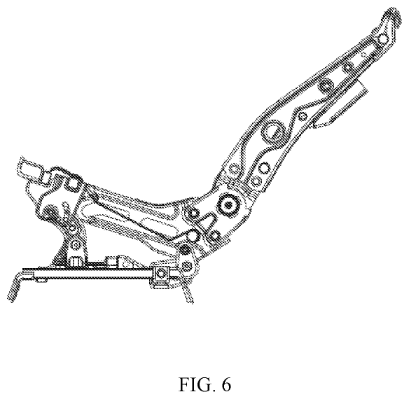

As shown in FIGS. 5-7, FIGS. 5-7 are respectively diagrams of inclined angle states of an automobile seat frame after the inclined angle adjustment mechanism of FIG. 3 is used. Where, FIG. 3 is a diagram of an original state of an inclined angle, FIG. 4 is a diagram of an intermediate state of an inclined angle, and FIG. 5 is a diagram of a maximum state of an inclined angle.

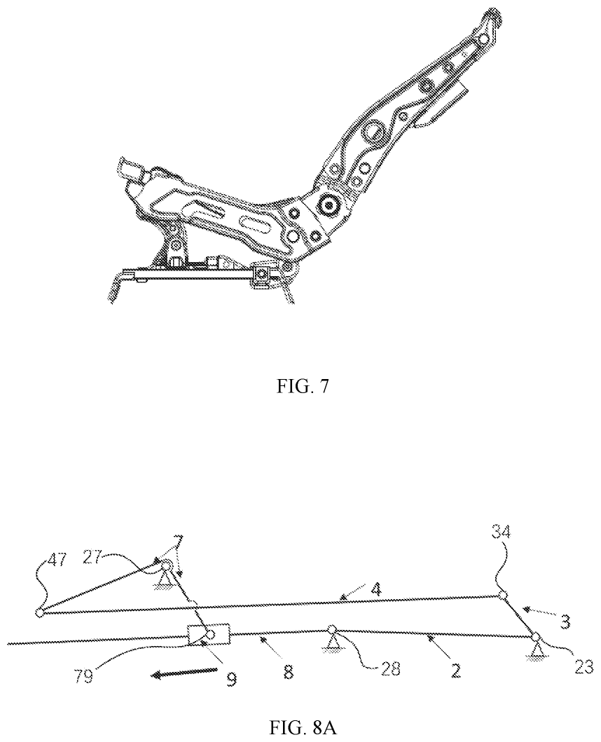

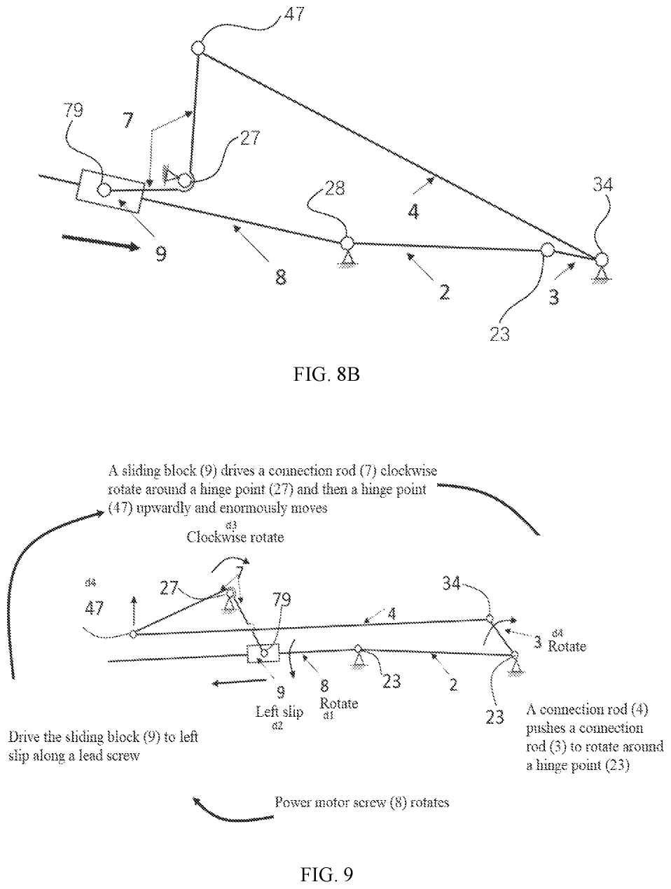

As shown in FIG. 8A and FIG. 8B, mechanical analysis principal graphs of a movement mechanism of an automobile seat under two inclined angle states of FIG. 5 and FIG. 7 are illustrated. As shown in FIG. 8A, FIG. 8A is a mechanical analysis diagram of a movement mechanism of an automobile seat when an original state of an inclined angle of FIG. 5 is in a state as delivered. FIG. 8B is a mechanical analysis diagram of a movement mechanism of an automobile seat when passengers rest at a maximum inclined angle state of FIG. 5.

As shown in FIG. 9, the rocker is used as a drive member such as a screw motor. When the screw motor rotates, rotation of the rocker 8 is sensed in a remote manner to drive the nut sleeve 9 in threaded coupling with the rocker 8 to move along the rocker 8, and meanwhile the rocker 8 swings up and down around a hinge point 28, the nut sleeve 9 drives the seventh connection rod 7 hinged with the nut sleeve 9 through a hinge point 79 to rotate around a hinge point 27, the seventh connection rod 7 drives the fourth connection rod 4 to move in a form of upwardly moving a hinge point 47, the fourth connection rod 4 drives the third connection rod 3 to move in a form of downwardly moving a hinge point 34 and rotate around a hinge point 23, finally, the hinge point 47 upwardly moves, the hinge point 34 descends, and the third connection rod 3 downwardly moves, so as to achieve the large angle adjustment of the fourth connection rod 4. Since the fourth connection rod 4 and the cushion skeleton 10 are fixed together, or both are integrated, the large angle adjustment of the seat is simultaneously achieved, which is increased by 10-25° compared with that in the existing technology. Specific situations are determined based on ratios in columns and practical demands.

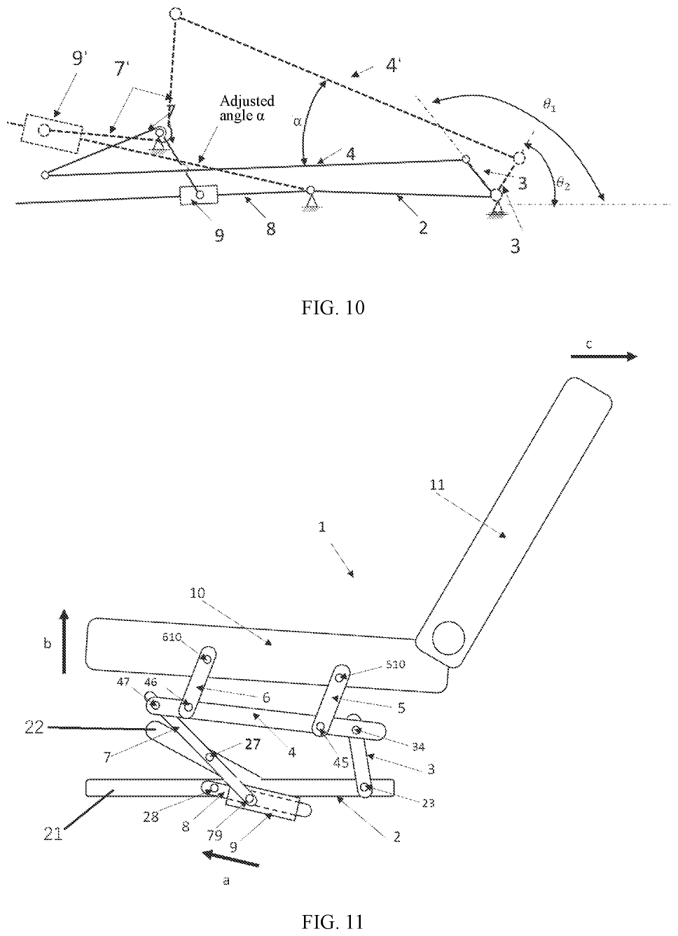

As shown in FIG. 10, the fourth connection rod 4 drives the third connection rod 3 to downwardly move around a hinge point 34 and rotate around a hinge 23, finally, the hinge point 47 upwardly moves, the hinge point 34 descends, the third connection rod 3 downwardly moves, the downward movement of the third connection rod 3 is rotary downward movement, a 01 to 02 change range of an included angle between the third connection rod 3 and a horizontal line during the seat adjustment is 135°-60°. In the movement process of the seat, the third connection rod 3 needs to bear a gravity and a foreign force from the whole seat, and therefore an included angle between the installation position of the third connection rod 3 and the horizontal line determines the bearing, adjusted angle and weight of the whole seat.

### Example 3

As shown in FIG. 11, an inclined angle adjustment mechanism is connected with a high adjustment mechanism. The high adjustment mechanism is a height adjustment mechanism, and includes a fifth connection rod 5 and a sixth connection rod 6, the front and back of the fourth connection rod 4 are respectively hinged with the lower ends of the fifth connection rod 5 and the sixth connection rod 6, and the upper ends of the fifth connection rod 5 and the sixth connection rod 6 are respectively hinged with the cushion skeleton 10. In this example, the nut sleeve 9 and the rocker 8 are respectively located on the back lower part of the pedestal 21, when the nut sleeve 9 forward moves, the nut sleeve 9 is farther and farther away from an intersection point between the rocker 8 and the pedestal 21, the inclined angle of the seat is increased. The nut sleeve 9 and the rocker 8 are respectively located on the front upper part of the pedestal 21, which leaves many spaces for the lower part of the automobile seat to facilitate the installation of the drive motor.

### Example 4

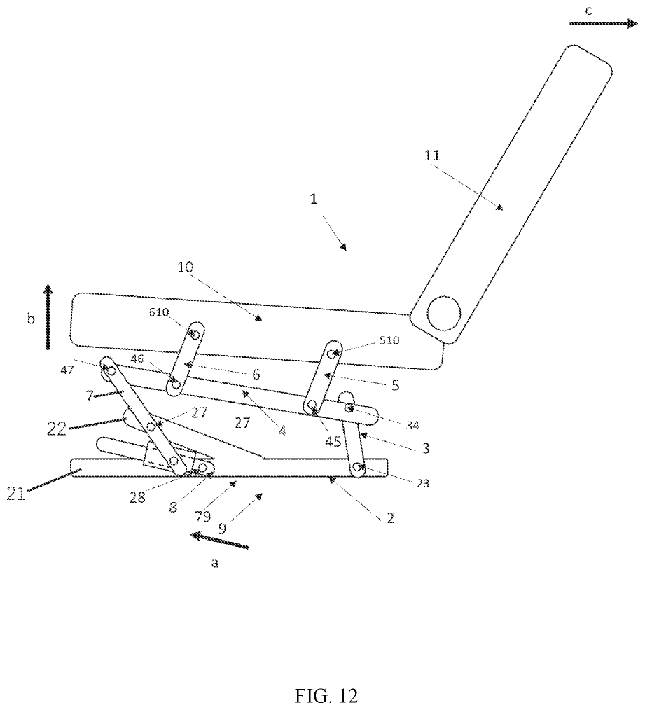

As shown in FIG. 12, the nut sleeve 9 and the rocker 8 are respectively located on the front upper part of the pedestal 21, when the nut sleeve 9 forward moves, the nut sleeve 9 is more and more closer to an intersection point between the rocker 8 and the pedestal 21, and the inclined angle of the seat is increased. The nut sleeve 9 and the rocker 8 are respectively located on the back lower part of the pedestal 21, which leaves a space for the front of the seat to facilitate the design of a leg support device for the front of the automobile seat. Other structures are the same as those in example 3.

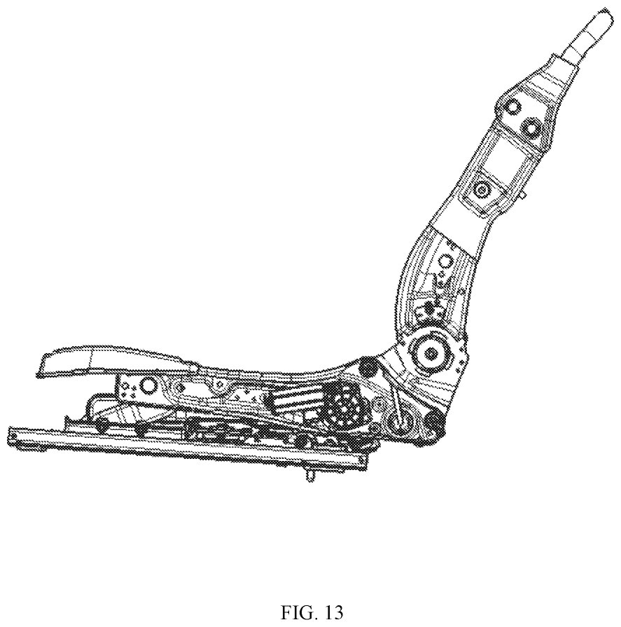

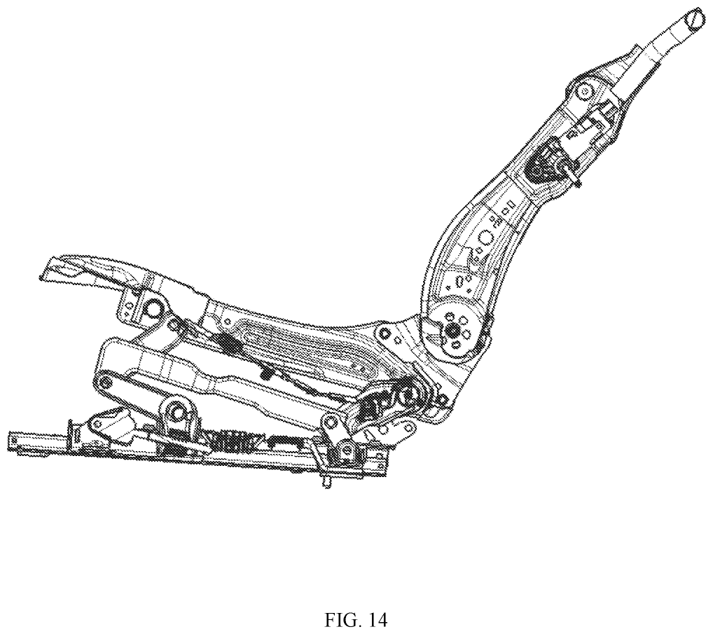

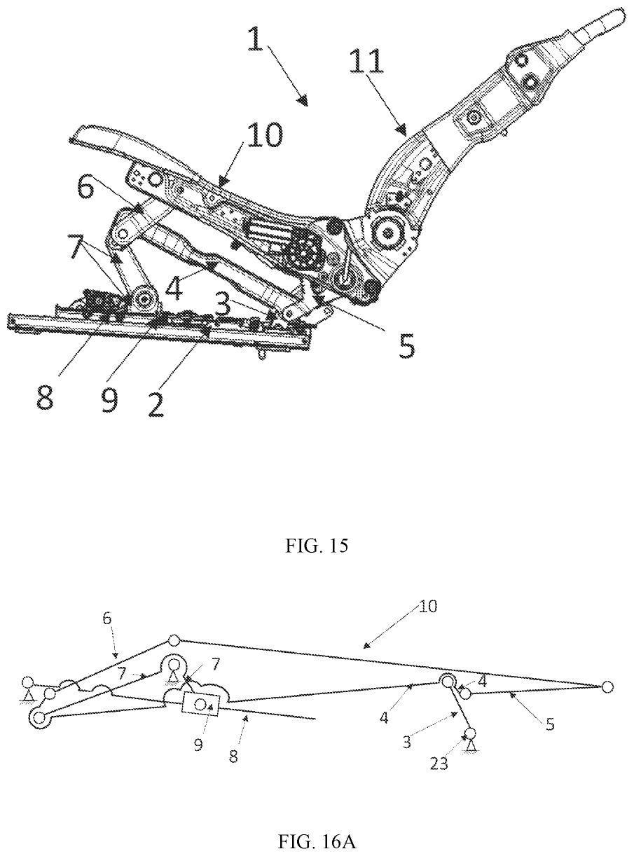

As shown in FIG. 13-FIG. 15, FIG. 13-FIG. 15 are respectively diagrams of inclined angle states of an automobile seat frame after an inclined angle adjustment mechanism and a high adjustment mechanism are used. Where, FIG. 13 is a diagram of an original state of an inclined angle and a high adjustment mechanism, FIG. 14 is a diagram of an intermediate state of an inclined angle and a high adjustment mechanism, and FIG. 15 is a diagram of a maximum state of an inclined angle and a high adjustment mechanism.

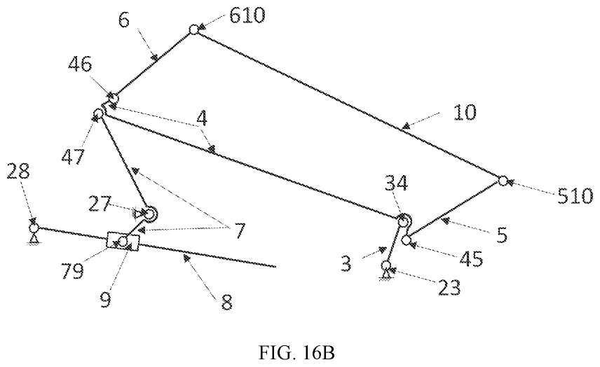

As shown in FIG. 16A and FIG. 16B, FIG. 16A and FIG. 16B are mechanical analysis principal graphs of a movement mechanism of an automobile seat under two inclined angle states of FIG. 13 and FIG. 15. As shown FIG. 16A, FIG. 16A is mechanical analysis diagram of a movement mechanism of an automobile seat when an original inclined angle state of FIG. 13 is in a state as delivered. FIG. 16B is a mechanical analysis diagram of a movement mechanism of an automobile seat when passengers rest under a maximum inclined angle state of FIG. 15.

The rocker is used as a drive member such as a screw motor. When the screw motor rotates, rotation of the rocker 8 is sensed in a remote manner to drive the nut sleeve 9 in threaded coupling with the rocker 8 to move along the rocker 8, and meanwhile the rocker 8 swings up and down around the hinge point 28, the nut sleeve 9 drives the seventh connection rod 7 hinged with the nut sleeve 9 through the hinge point 79 to rotate around the hinge point 27, the seventh connection rod 7 drives the fourth connection rod 4 to move in a form of upwardly moving the hinge point 47, the fourth connection rod 4 drives the fifth connection rod 5 and the sixth connection rod 6 to respectively upwardly move, the fifth connection rod 5 and the sixth connection rod 6 lift the cushion skeleton 10 through a hinge point 45, a hinge point 46, a hinge point 510 and a hinge point 610 so as to elevate the seat. At the same time, the fourth connection rod 4 drives the third connection rod 3 to downwardly move around the hinge point 34 ad rotate around the hinge point 23, finally, the hinge point 47 upwardly moves, the hinge point 34 descends, the third connection rod 3 downwardly moves, so as to achieve the large angle adjustment of the fourth connection rod 4. Therefore, the purpose of large angle adjustment is reached while elevating the seat, which is increased by 10-35° compared with that in the existing technology. Through adoption of the design of the present disclosure, the angle adjustment magnitude can be greater. Specific situations are determined based on ratios in columns and practical demands, which is unprecedented in this industry.

We claim:

1. An automobile seat based on an inclined angle adjustment mechanism, comprising a seat body including a cushion skeleton, a backrest skeleton, and a base arranged under the seat body, further comprising an inclined angle adjustment mechanism, wherein the inclined angle adjustment mechanism comprises a third connection rod, a fourth connection rod and a seventh connection rod, the upper surface of the base is of a non-plane structure and includes a pedestal located at the lower part and a branch located at the upper part which are integrated or connected by a fixed member, the back of the pedestal is moveably connected with the lower end of the third connection rod, the front of the pedestal is moveably connected with a length-variable connection rod, the length-variable connection rod is moveably connected with the lower part of the third connection rod, the upper end of the seventh connection rod is moveably connected with the front of the forth connection rod, the back of the forth connection rod is moveably connected with the upper part of the third connection rod, the middle of the seventh connection rod is moveably connected with the upper end of the branch, and the length-variable connection rod is connected with a drive device.

2. The automobile seat is based on the inclined angle adjustment mechanism according to claim 1, wherein the length-variable connection rod adopts a threaded nut device, a shaft sleeve device, a sliding block, and chute device, a gear/rack device, or a ball screw device.

3. The automobile seat is based on the inclined angle adjustment mechanism according to claim 2, wherein the threaded nut device comprises a nut sleeve and a rocker, an external thread is arranged on the outside of the rocker, a corresponding internal thread is arranged inside the nut sleeve, the lower part of the seventh connection rod is movably connected with the middle of the nut sleeve, and the middle of the pedestal is movably connected with one endpoint of the rocker.

4. he automobile seat is based on the inclined angle adjustment mechanism according to to claim 3, wherein the nut sleeve and the rocker are respectively located on the front upper part of the pedestal, when the nut sleeve forward moves, the nut sleeve is farther and farther away from an intersection point between the rocker and the pedestal, and the inclined angle of the seat is increased.

5. The automobile seat is based on the inclined angle adjustment mechanism according to claim 3, wherein the nut sleeve and the rocker are respectively located on the back lower part of the pedestal, when the nut sleeve forward moves, the nut sleeve is closer and closer to an intersection point between the rocker and the pedestal, and the inclined angle of the seat is increased.

6. The automobile seat is based on the inclined angle adjustment mechanism according to claim 1, wherein the fourth connection rod is fixed at the bottom of the cushion skeleton, or the fourth connection rod is replaced by the cushion skeleton.

7. The automobile seat is based on the inclined angle adjustment mechanism according to claim 1, wherein the drive device adopts an electric drive, hydraulic drive, pneumatic drive, or electromagnetic drive manner.

8. The automobile seat is based on the inclined angle adjustment mechanism according to to claim 7, wherein the electric drive adopts a screw motor, when the screw motor rotates, the rocker is driven to rotate so that the nut sleeve moves along the rocker and meanwhile the rocker swings up and down around a hinge point between the rocker and the pedestal, the movement of the nut sleeve drives the seventh connection rod to rotate around a hinge point located in the middle of the seventh connection rod, the rotation of the seventh connection rod drives the upward movement of the fourth connection rod, and the upward movement of the fourth connection rod drives the downward movement of the third connection rod, so as to realize the large angle adjustment of the fourth connection rod, and the movement of the fourth connection rod drives the large angle adjustment of the cushion skeleton and the backrest skeleton.

9. The automobile seat is based on the inclined angle adjustment mechanism according to claim 1, wherein the inclined angle adjustment mechanism is connected with a high adjustment mechanism, the high adjustment mechanism comprises a fifth connection rod and a sixth connection rod, the front, and back of the fourth connection rod are respectively movably connected with the lower ends of the fifth connection rod and the sixth connection rod, and the upper ends of the fifth connection rod and the sixth connection rod are respectively movably connected with the cushion skeleton.

10. The automobile seat is based on the inclined angle adjustment mechanism according to claim 1, wherein a ratio of the length from the hinge point to the hinge point of the seventh connection rod to the length of the third connection rod is 2:1-3:1, which realizes the large angle adjustment of the fourth connection rod and increases the seat adjustment angle by 10-35° compared with the seat adjustment angle in the existing technology.
